(19) United States
(12) Patent Application Publication
(10) Pub. No.: US 2011/0227959 A1
(43) Pub. Date: Sep. 22, 2011

(54) LIQUID CRYSTAL DISPLAY AND DATA DRIVING DEVICE

(75) Inventor: Mamoru Chiba, Kanagawa (JP)

(73) Assignee: KABUSHIKI KAISHA TOSHIBA, Tokyo (JP)

(21) Appl. No.: 13/022,892

(22) Filed: Feb. 8, 2011

(30) Foreign Application Priority Data
Mar. 19, 2010 (JP) 2010-064918

(51) Int. Cl. G09G 5/10; G09G 3/36

(52) U.S. Cl. 345/690; 345/89

(57) ABSTRACT

According to the embodiments, a data driving circuit of a liquid crystal display includes a plurality of data lines respectively connected to the liquid crystal cells, a plurality of gradation voltage supplying units which are connected to the respective data lines to supply the respective gradation voltages to the plurality of liquid crystal cells, and a plurality of charge sharing units short at least the adjacent gradation voltage supplying units, at a position posterior to the respective gradation voltage supplying units and prior to the data lines to which the respective gradation voltage supplying units are connected, when a gradation value of a gradation signal is in a predetermined range.

### CROSS-REFERENCE TO RELATED APPLICATIONS

This application is based upon and claims the benefit of priority from the prior Japanese Patent Application No. 2010-064918, filed on Mar. 19, 2010; the entire contents of which are incorporated herein by reference.

### FIELD

Embodiments described herein relate generally to a liquid crystal display and a data driving device.

### BACKGROUND

In a liquid crystal display, each polarity of gradation voltages is inverted between neighboring liquid crystal cells in each frame period in order to decrease a degradation of liquid crystals. This method, however, extremely fluctuates gradation voltages supplied to data lines every time each polarity of the gradation voltages is inverted. As a result, a lot of current is generated in a data driving circuit, hence to increase a heat generating temperature of the data driving circuit.

In the conventional art, a charge sharing circuit for temporarily shorting between neighboring terminals of output terminals for the gradation voltages is added to the data driving circuit, to perform a charge sharing process for charging/discharging a charge by shorting between the adjacent terminals before supplying the gradation voltages. This can decrease a rapid fluctuation of the gradation voltages at the polarity inversion.

The conventional data driving circuit, however, performs the charge sharing process on all the terminals, every time upon receipt of a charge sharing signal entered externally, regardless of a fluctuation in the gradation voltages. Therefore, the conventional data driving circuit may consume electric current wastefully. Further, it takes a lot of time in output processing of the gradation voltage, which causes an increase of heat generation amount and power consumption.

### BRIEF DESCRIPTION OF THE DRAWINGS

FIG. 1 is a block diagram showing a structure of a liquid crystal display according to a first embodiment;

FIG. 2 is an equivalent circuit diagram showing a liquid crystal cell of the liquid crystal display panel shown in FIG. 1;

FIG. 3 is a view showing an example of gradation voltages supplied in accordance with the respective gradation values;

FIG. 4 is a view for use in describing the structure of the data driving circuit shown in FIG. 1;

FIG. 5 is a view showing a timing chart of the signals entered into the data driving circuit shown in FIG. 1 and the gradation voltages supplied therefrom;

FIG. 6 is a view for use in describing a structure of a data driving circuit according to a second embodiment;

FIG. 7 is a view showing a timing chart of the signals entered into the data driving circuit shown in FIG. 6 and the gradation voltages supplied therefrom;

FIG. 8 is a view showing another example of a timing chart of the signals entered into the data driving circuit shown in FIG. 6 and the gradation voltage supplied therefrom;

FIG. 9 is a view for use in describing a structure of a data driving circuit according to a third embodiment;

FIG. 10 is a view showing a timing chart of the signals entered into the data driving circuit shown in FIG. 9 and the gradation voltages supplied therefrom; and

FIG. 11 is a view showing another example of a timing chart of the signals entered into the data driving circuit shown in FIG. 9 and the gradation voltages supplied therefrom.

### DETAILED DESCRIPTION

In general, according to embodiments, a data driving circuit of a liquid crystal display includes a plurality of data lines connected to the respective liquid crystal cells, a plurality of gradation voltage supplying units which are connected to the respective data lines to supply the respective gradation voltages to the respective liquid crystal cells, and a plurality of charge sharing units short at least the adjacent gradation voltage supplying unit, when a gradation ,value of a gradation signal is in a predetermined range, at the position posterior to the respective gradation voltage supplying units and prior to the data lines to which the respective gradation voltage supplying units are connected.

Hereinafter, exemplary embodiments of a liquid crystal display and a data driving circuit will be explained in detail with reference to the accompanying drawings. The present invention is not limited to the following embodiments.

### First Embodiment

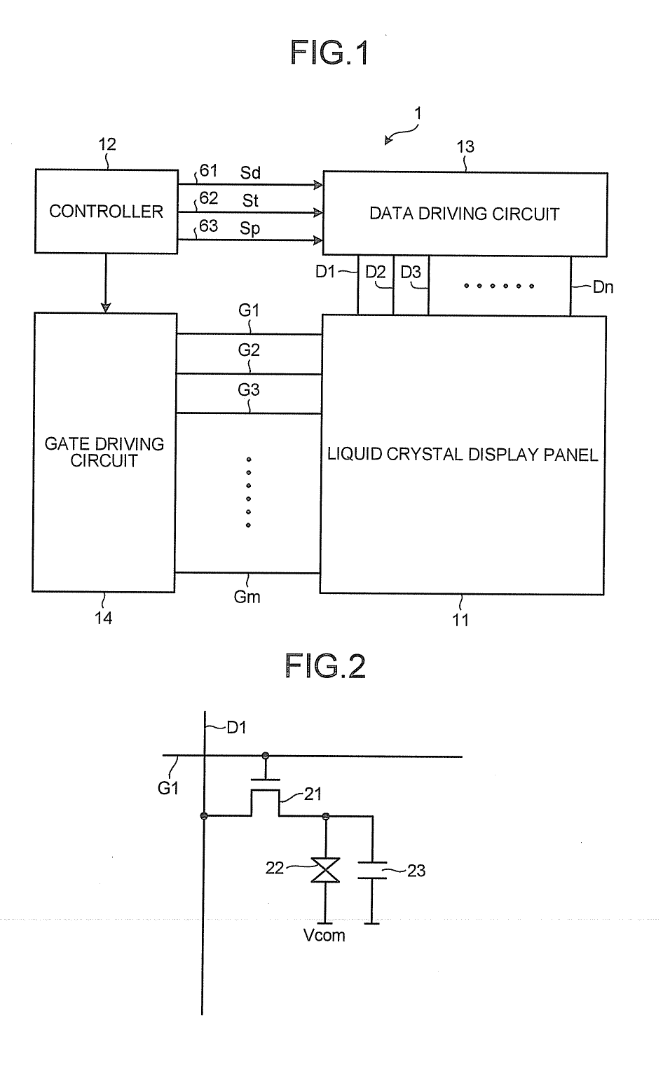

FIG. 1 is a block diagram showing a structure of a liquid crystal display according to a first embodiment of the invention.

As illustrated in FIG. 1, the liquid crystal display 1 according to the first embodiment includes a liquid crystal display panel 11, a controller 12, a data driving circuit 13, and a. gate driving circuit 14.

The liquid crystal display panel 11 has a plurality of gate lines G1 to Gm arranged in a predetermined direction, a plurality of data lines D1 to Dn arranged orthogonally to the respective gate lines G1 to Gm, and a plurality of liquid crystal cells which are arranged in a matrix, being connected to the gate lines G1 to Gm and the data lines D1 to Dn respectively, for displaying individual colors independently.

Each liquid crystal cell is formed by injecting liquid crystal molecules between two glass substrates. For example, as illustrated in FIG. 2, one liquid crystal cell 22 is connected to the data line D1 and the gate line G1 through a thin film transistor 21. The liquid crystal cell 22 receives a gradation voltage through the data line D1 when the thin film transistor 21 is turned on upon receipt of a gate signal from the gate line G1. A capacitor 23 keeps the gradation voltage supplied to the liquid crystal cell 22. The liquid crystal display panel 11 has a color filter not illustrated.

The controller 12 enters a gradation signal Sd into the data driving circuit 13 through a wiring 61 and controls a driving timing of the data driving circuit 13 and a driving timing of the gate driving circuit 14. The controller 12 enters a load signal St for instructing a timing of supplying the gradation voltage through a wiring 62 and enters a polarity control signal Sp for instructing polarity inversion of the gradation voltage through a wiring 63, into the data driving circuit 13.

The data driving circuit 13 supplies the respective gradation voltages corresponding to the colors displayed by a plurality of liquid crystal cells to the respective liquid crystal cells. The data driving circuit 13 supplies the gradation voltages corresponding to the gradation signals Sd to the respective liquid crystal cells connected to the data lines D1 to Dn, through the data lines D1 to Dn, based on the gradation signals Sd, load signals St, polarity control signals Sp entered from the controller 12.

The gate driving circuit 14 supplies gate signals to the gate lines G1 to Gm, according to the respective control signals entered from the controller 12.

The data driving circuit 13 shown in FIG. 1 judges whether charge sharing process is performed or not, according to whether or not the gradation value of the gradation signal Sd entered from the controller 12 is within a predetermined range. The gradation signal Sd is represented as a gradation value from 00h to ffh in the 256 gradations, for example.

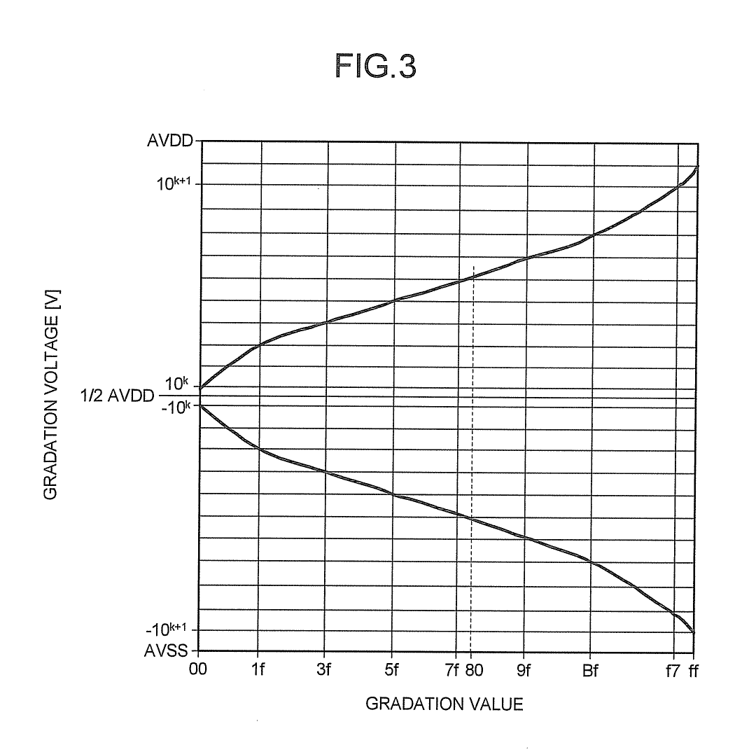

FIG. 3 is a view showing an example of the gradation voltages supplied in accordance with the respective gradation values.

As illustrated in FIG. 3, the gradation voltage to be supplied is set exponentially higher according as the gradation value gets larger.

The data driving circuit 13 decides whether the charge sharing process is performed or not, with respect to the boundary 7fh in the middle of the gradation values 00h to ffh expressed in hexadecimal notation.

The data driving circuit 13 does not perform the charge sharing process when the gradation value of a gradation signal Sd is within the range of 00h to 7fh. It is because a fluctuation in the gradation voltage at the polarity inversion is small in the above range.

When the gradation value of a gradation signal Sd is within the range of 80h to ffh, the data driving circuit 13 performs the charge sharing process to reduce a heat generation amount. In this case, it is because a fluctuation in the gradation voltage at the polarity inversion is great and lots of heat generation happens.

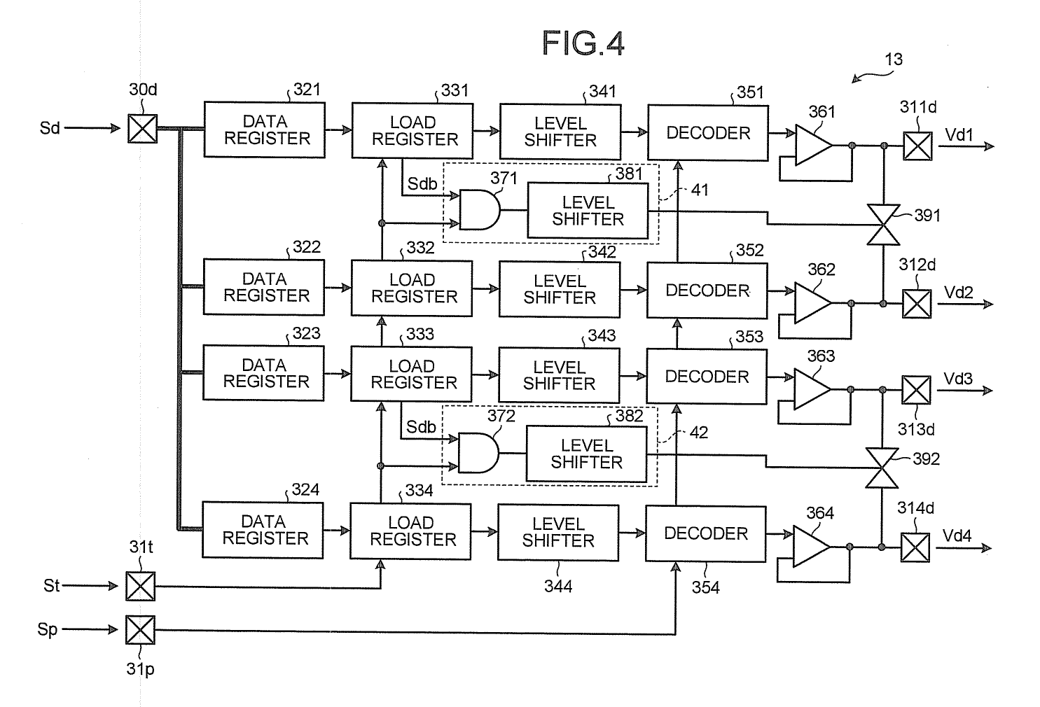

Next, the data driving circuit 13 will be described. FIG. 4 is a view for use in describing the structure of the data driving circuit 13 shown in FIG. 1. FIG. 4 shows one portion of the data driving circuit 13.

As illustrated in FIG. 4, the data driving circuit 13 has a gradation signal input terminal 30d for entering the gradation signal Sd, a load control terminal 31t for entering the load signal St, a polarity control terminal 31p for entering the polarity control signal Sp, and data output terminals 311d to 314d for supplying the respective gradation voltages to the respective data lines D1 to Dn.

The gradation signal input terminal 30d is connected to the wiring 61. The load control terminal 31t is connected to the wiring 62. The polarity control terminal 31p is connected to the wiring 63. The respective data output terminals 311d to 314d are connected to the respective corresponding data lines D1 to D4. FIG. 4 shows the respective data output terminals 311d to 314d corresponding to the respective data lines D1 to D4 and the respective components connected to the data output terminals 311d to 314d, of the data lines D1 to Dn, for the sake of brief description.

The data driving circuit 13 has a plurality of gradation voltage supplying units which are connected to the data lines D1 to Dn to supply the gradation voltages corresponding to the colors displayed by the liquid crystal displays, to the respective liquid crystal displays.

The data driving circuit 13 has a data register 321 connected to the gradation signal input terminal 30d, a load register 331 connected to the data register 321 and the load control terminal 31t, a level shifter 341 connected to the load register 331, a decoder 351 connected to the level shifter 341 and the polarity control terminal 31p, and an amplifier 361 connected to the decoder 351, as a gradation voltage supplying units corresponding to the data line connected to the data output terminal 311d.

The gradation signal Sd entered into the data register 321 is moved to the load register 331.

The load register 331 supplies the gradation signal Sd to the decoder 351 through the level shifter 341 when the load signal 31t gets from a high voltage 1 to a low voltage 0.

Then, the decoder 351 performs DA conversion on the output gradation signal Sd into the gradation voltage corresponding to the gradation signal Sd.

The amplifier 361 amplifies the gradation voltage DA converted by the decoder 351.

The data output terminal 311d supplies the gradation voltage amplified by the amplifier 361.

The decoder 351 supplies the gradation voltage with its polarity inverted, to the amplifier 361 when the value of the input polarity control signal Sp is changed.

The gradation voltage supplied from the data output terminal 311d is supplied to the respective liquid crystal cells connected to the data line D1 through the data line D1 connected to the data output terminal 311d.

It is the same as for the other data output terminals 312d to 314d. Specifically, the other respective data output terminals 312d to 314d have the respective data registers 322 to 324 connected to the gradation signal input terminal 30d, the respective load registers 332 to 334 connected to the respective data registers 322 to 324 and the load control terminal 31t, the respective level shifters 342 to 344 connected to the respective load registers 332 to 334, the respective decoders 352 to 354 connected to the respective level shifters 342 to 344 and the polarity control terminal 31p, and the respective amplifiers 362 to 364 connected to the respective decoders 352 to 354.

The data driving circuit 13 has analog switches 391 and 392 in each data line which connects the adjacent two terminals of the data output terminals 311d to 314d.

The analog switch 391 shorts between the adjacent data output terminals 311d and 312d upon receipt of an operation signal. The analog switch 392 shorts between the adjacent data output terminals 313d and 314d upon receipt of the operation signal.

Here, the gradation signal Sd is 8 bit data indicating 256 gradations, for example, from 00h to ffh. The upmost bit of the gradation signal Sd is 0 in the range of the gradation value from 00h to 7fh and 1 in the range of the gradation value from 80h to ffh.

The charge sharing units in the data driving circuit 13 takes out the upmost bit of the gradation signal Sd. The data driving circuit 13 judges whether or not the gradation value of the gradation signal Sd is within the range of 80h to ffh targeted for the charge sharing, according to the taken upmost bit 0 or 1 and decides to or not to perform the charge sharing process.

The data driving circuit 13 does not perform the charge sharing when the upmost bit of the taken gradation signal Sd is 0. The data driving circuit 13 performs the charge sharing when the upmost bit is 1.

The data driving circuit 13 has AND circuits 371 and 372 and level shifters 381 and 382 respectively connected to the AND circuits 371 and 372 in every adjacent two terminals.

The respective level shifters 381 and 382 are connected to the respective analog switches 391 and 392. These analog switches 391 and 392 form the charge sharing units. The charge sharing units short the adjacent data output terminals of 311d to 314d, at a position posterior to the gradation voltage supplying units and prior to the data lines D1 to D4 to which the gradation voltage supplying units are connected.

The AND circuit 371 provided between the data output terminals 311d and 312d is connected to the load register 331 corresponding to the data output terminal 311d and the load control terminal 31t.

The load register 331 enters the upmost bit Sdb of the gradation signal Sd into the AND circuit 371. The load control terminal 31t enters the load signal St into the AND circuit 371.

The AND circuit 371 supplies a signal corresponding to a logical value 1 to the level shifter 381 when both the entered upmost bit Sdb and load signal St have the logical value 1. The level shifter 381 supplies an operation signal to the connected analog switch 391 when receiving 1 from the AND circuit 371. The analog switch 391 is turned on upon receipt of the operation signal from the level shifter 381 and shorts between the adjacent data output terminals 311d and 312d, namely the gate lines D1 and D2, so as to perform the charge sharing process for charging/discharging the charge.

The AND circuit 371 supplies a signal corresponding to a logical value 0 to the level shifter 381 when at least one of the entered upmost bit Sdb and load signal St has the logical value 0. In this case, the level shifter 381 does not supply any operation signal nor the analog switch 391 does not perform the charge sharing process. The AND circuit 371 and the level shifter 381 form a operation signal supplying unit 41.

The AND circuit 372 provided between the data output terminals 313d and 314d performs the same operation as the AND circuit 371. The AND circuit 372 receives the upmost bit Sdb of the gradation signal Sd from the connected load register 333 and the load signal St from the load control terminal 31t. The AND circuit 372 supplies a signal corresponding to the logical value 1 to the level shifter 382 when both the upmost bit Sdb and the load signal St have the logical value 1. Consequently, when receiving 1, the level shifter 382 supplies an operation signal to the analog switch 392. The analog switch 392 is turned on upon receipt of the operation signal from the level shifter 382 and shorts between the adjacent data output terminals 313d and 314d to perform the charge sharing process for charging/discharging the charge. The AND circuit 372 and the level shifter 382 form a operation signal supplying unit 42. In the data driving circuit, the gradation voltage supplying units and the charge sharing units are similarly formed as for the data lines D5 to Dn other than the data lines D1 to D4.

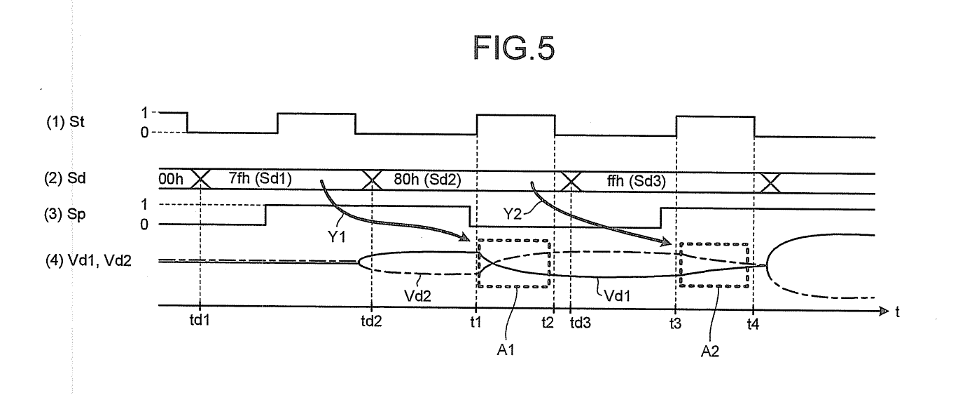

An output voltage supplied from each of the data output terminals 311d and 312d shown in FIG. 4 will be described with reference to the timing chart in the data driving circuit 13. FIG. 5(1) is a timing chart of the load signal St entered into the data driving circuit 13. FIG. 5(2) is a timing chart of the gradation signal Sd entered into the data driving circuit 13. FIG. 5(3) is a timing chart of the polarity control signal Sp entered into the data driving circuit 13. FIG. 5(4) is a timing chart of the output voltages Vd1 and Vd2 supplied from the data output terminals 311d and 312d shown in FIG. 4 to the data lines D1 and D2.

The case of receiving the gradation signal Sd1 having the gradation value 7fh will be described. As illustrated in FIG. 5(2), the gradation signal Sd1 indicating the gradation value 7fh between time td1 to td2 is written. In this case, the upmost bit of the gradation signal Sd1 is 0 because the gradation value is 7fh. Therefore, during time from t1 to t2 when the load signal St is turned to 1 next time, even when the polarity control signal Sp is turned from the logical value 1 corresponding to a high voltage to the logical value 0 corresponding to a low voltage in order to instruct the polarity inversion, any operation signal as for the gradation signal Sd1 is not supplied to the analog switch 391, as indicated by an arrow Y1, and no charge sharing process is performed, as illustrated in an area A1. As a result, at the time t1 when the load signal St is turned to 1, each polarity of the gradation voltages is inverted according to a change of the polarity control signal Sp of FIG. 5(3), and during the display period from time t2 to t3 when the load signal St indicates 0 next time, the gradation voltages corresponding to the gradation signal Sd1 are supplied as the output voltages Vd1 and Vd2.

The case of receiving the gradation signal Sd2 having the gradation value 80h next to the gradation signal Sd1 and written between time td2 to td3 will be described. In this case, the upmost bit of the gradation signal Sd2 is 1. Therefore, as indicated by an arrow Y2, the operation signal is supplied to the analog switch 391 between time t3 to t4 when the load signal St is turned to 1 at the next timing after the gradation signal Sd2 is written and the analog switch 391 is turned on, so as to perform the charge sharing process for charging/discharging the charge, as illustrated in an area A2. Consequently, at the time t4 when the load signal St is turned to 0, each polarity of the gradation voltages is inverted. During the display period of the time t4 and later, the gradation voltages corresponding to the gradation value 80h of the gradation signal Sd2 are supplied as the output voltages Vd1 and Vd2. The upmost bit of the gradation signal Sd3 indicating the gradation value ffh entered next to the gradation signal Sd2 is 1. Therefore, the charge sharing process is performed during the period when the load signal St is turned to 1 at the next timing of writing the gradation signal Sd3.

As mentioned above, in the liquid crystal display 1 according to the first embodiment, the data driving circuit 13 itself judges whether to or not to do the charge sharing process, based on the gradation value of the entered gradation signal Sd.

Namely, the data driving circuit 13 selectively performs the charge sharing process in accordance with the gradation value of the gradation signal Sd. Therefore, according to the first embodiment, it is possible to properly save the power consumption in the data driving circuit 13 and efficiently perform the output processing of the gradation voltage to the liquid crystal display panel 11.

The data driving circuit 13 selectively performs the charge sharing process when the gradation value of the gradation signal Sd is, for example, in the range of 80h to ffh having a large fluctuation in the gradation voltage at the polarity inversion. Therefore, according to the first embodiment, the data driving circuit 13 can be avoided from getting high in the temperature due to the heat generation.

This embodiment makes it possible to select the charge sharing process just by changing the wiring structure inside the data driving circuit 13 and the circuit structure. Therefore, the structure of the first embodiment can be realized without increasing the manufacturing process of the original data driving circuit 13.

The data driving circuit 13 does not need any external charge sharing signal because whether the charge sharing process is performed or not is judged inside the data driving circuit 13. Therefore, the liquid crystal display 1 does not need the connection wiring between the controller and the data driving circuit for entering the charge sharing signal conventionally required and the terminal for the connection wiring. According to the first embodiment, it is possible to save the power consumption and reduce the heat generation amount in the simple structure as it is.

The data driving circuit 13 according to the first embodiment has been described taking the case of judging whether to or not to perform the charge sharing process with the boundary fixed in the range of 7fh to 80h, that is the middle of the gradation values 00h to ffh; however, it is not restricted to this.

For example, the boundary value corresponding to the gradation range of actually generating heat may be set so that the charge sharing process can be actually performed in the above heat generating gradation range within the data driving circuit for every product. In other words, in the first embodiment, the gradation range of performing the charge sharing process may be set arbitrarily correspondingly to the gradation range of actually generating heat at the polarity inversion of the gradation voltage. In this case, of the gradation signal Sd, a bit at a position corresponding to this boundary may be set to supply from the load registers 331 and 333 to the AND circuits 371 and 372.

### Second Embodiment

Next, a second embodiment will be described. In the second embodiment, a data driving circuit will be described in the case where whether or not the gradation value of a gradation signal is in a predetermined range is judged and whether to or not to perform the charge sharing process is judged according to the polarity control signal corresponding to the above gradation signal.

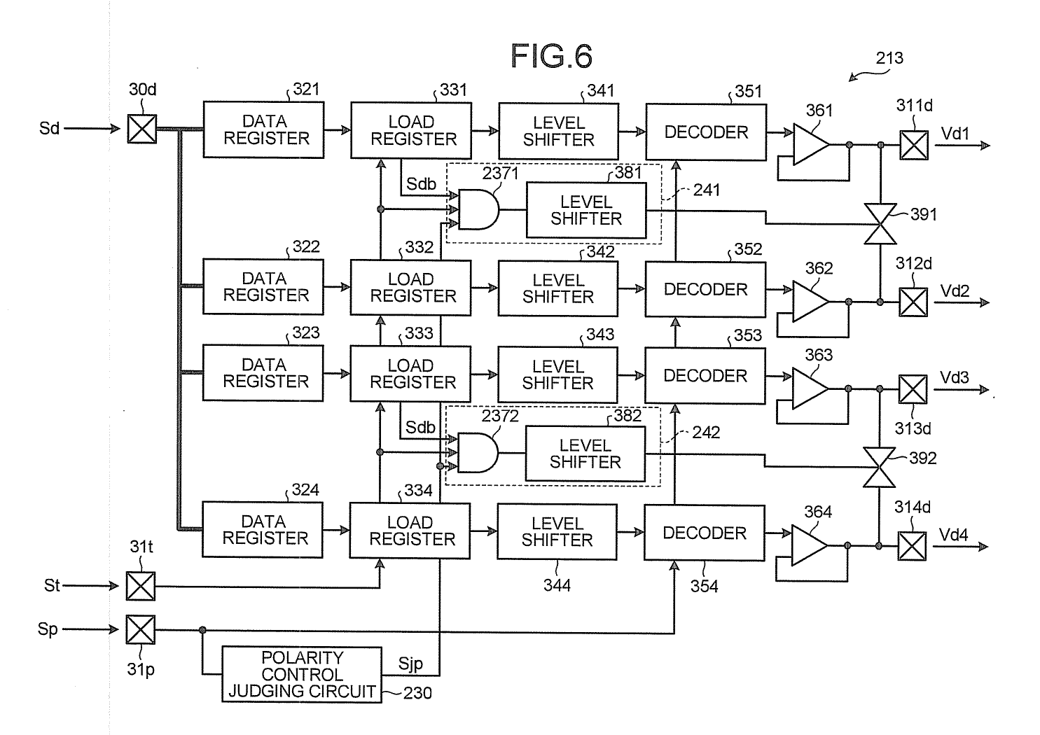

With reference to FIG. 6, a data driving circuit according to the second embodiment will be described.

FIG. 6 is a view for use in describing the structure of the data driving circuit according to the second embodiment. The liquid crystal display according to the second embodiment is formed by substituting a data driving circuit 213 described in FIG. 6 for the data driving circuit 13 of the liquid crystal display 1 shown in FIG. 1.

The data driving circuit 213 shown in FIG. 6 performs the charge sharing process when a polarity control signal Sp corresponding to a gradation signal Sd instructs a polarity inversion and the gradation value of the gradation signal Sd is in a predetermined range of 80h to ffh.

The data driving circuit 213 does not perform the charge sharing process in the whole gradation range (00h to ffh) of the gradation signal Sd when the polarity control signal Sp corresponding to the gradation signal Sd does not indicate the polarity inversion.

The data driving circuit 213 does not perform the charge sharing process in a predetermined range of the gradation values 00h to 7fh of the gradation signal Sd even when the polarity control signal Sp corresponding to the gradation signal Sd indicates the polarity inversion.

As illustrated in FIG. 6, the data driving circuit 213 further includes a polarity control judging circuit 230 which judges the presence of the polarity inversion instruction in the polarity control signal Sp entered into a polarity control terminal 31p.

The polarity control judging circuit 230 supplies the logical value 1 to AND circuits 2371 and 2372 as a polarity judging signal Sjp when the polarity control signal Sp is judged to instruct the polarity inversion.

The polarity control judging circuit 230 supplies the logical value 0 to the AND circuits 2371 and 2372 as the polarity judging signal Sjp when the polarity control signal Sp is not judged to instruct the polarity inversion.

The AND circuit 2371 supplies the logical value 1 to a level shifter 381 when the value of an upmost bit Sdb of the entered gradation signal Sd, the value of a load signal St, and the value of the polarity judging signal Sjp are all 1. The level shifter 381 supplies an operation signal. The analog switch 391 is turned on. As a result, the adjacent data output terminals 311d and 312d are shorted, so as to charge/discharge the charge.

The AND circuit 2371 supplies the logical value 0 to the level shifter 381 when at least one of the values of the entered upmost bit Sdb, the load signal St, and the polarity judging signal Sjp is 0. In this case, the level shifter 381 does not supply the operation signal. As a result, the analog switch 391 is not turned on and the charge sharing process is not performed. The AND circuit 2371 and the level shifter 381 form a operation signal supplying unit 241.

Similarly to the AND circuit 2371, the AND circuit 2372 supplies the logical value 1 to a level shifter 382 when the value of the entered upmost bit Sdb, the value of the load signal St, and the value of the polarity judging signal Sjp are all 1. The AND circuit 2372 supplies the logical value 0 to the level shifter 382 when at least one of the values of the entered upmost bit Sdb, the load signal St, and the polarity judging signal Sjp is 0. The AND circuit 2372 and the level shifter 382 form a operation signal supplying unit 242.

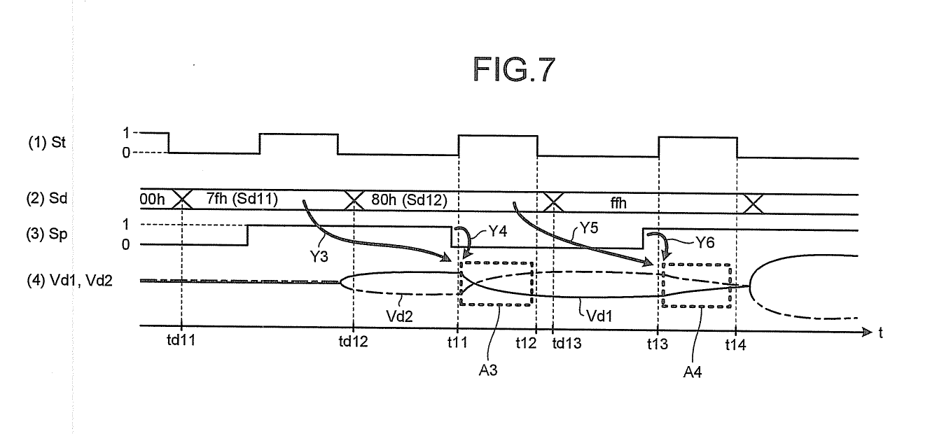

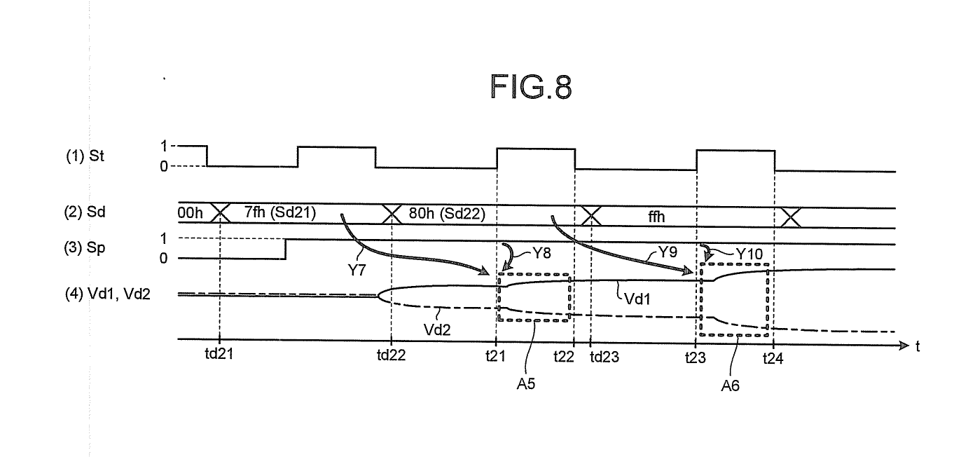

More specifically, the output voltages supplied from the data output terminals 311d and 312d of the data driving circuit 213 shown in FIG. 6 will be described with reference to FIGS. 7 and 8.

FIG. 7(1) is a timing chart of the load signal St entered into the data driving circuit 213. FIG. 7(2) is a timing chart of the gradation signal Sd entered into the data driving circuit 213. FIG. 7(3) is a timing chart of the polarity control signal Sp entered into the data driving circuit 213. FIG. 7(4) is a timing chart of output voltages Vd1 and Vd2 supplied from the data output terminals 311d and 312d of FIG. 6 to data lines D1 and D2.

FIG. 8(1) is another timing chart of the load signal St entered into the data driving circuit 213. FIG. 8(2) is another timing chart of the gradation signal Sd entered into the data driving circuit 213. FIG. 8(3) is another timing chart of the polarity control signal Sp entered into the data driving circuit 213. FIG. 8(4) is another timing chart of the output voltages Vd1 and Vd2 supplied from the data output terminals 311d and 312d of FIG. 6 to the data lines D1 and D2.

As illustrated in FIG. 7(2), when a gradation signal Sd11 having the gradation value 7fh is written between time td11 to td12, the upmost bit of the gradation signal Sd11 is 0. Therefore, even when the polarity control signal Sp is turned from 1 to 0 in order to instruct the polarity inversion, between time t11 to t12 when the load signal St is turned to 1 next time, the level shifter 381 does not supply the operation signal to the analog switch 391. Therefore, as indicated by arrows Y3 and Y4, the charge sharing process is not performed on the gradation signal Sd11, as illustrated in an area A3 of FIG. 7(4), during the t11 to t12. As a result, at the time t11 when the load signal St is turned to 1, each polarity of the gradation voltages is inverted according to a change of the polarity control signal Sp of FIG. 7(3). Consequently, during the display period from time t12 to t13 when the load signal St is turned to 0 next time, the gradation voltages corresponding to the gradation signal Sd11 are supplied as the output voltages Vd1 and Vd2.

As illustrated in FIG. 7, the period from time td12 to td13 will be described. When a gradation signal Sd12 having the gradation value 80h is written, during the period from time t13 and t14 when the load signal St is turned to 1 at the next timing after the writing of the gradation signal Sd12, the level shifter 381 supplies the operation signal to the analog switch 391, when the polarity control signal Sp is turned from 0 to 1 so as to instruct the polarity inversion. Therefore, as indicated by arrows Y5 and Y6, the analog switch 391 is turned on and the charge sharing process for charging/discharging the charge is performed on the gradation signal Sd12, during time t13 to t14, as illustrated in an area A4. At the time t14 when the load signal St is turned to 0,each polarity of the gradation voltages is inverted, and during the display period of the time t14 and later, the gradation voltages corresponding to the gradation signal Sd12 having the gradation value 80h are supplied as the output voltages Vd1 and Vd2.

As illustrated in FIG. 8, the case where a gradation signal Sd22 having the gradation value 80h is written between time td22 to td23 will be described. In this case, since the polarity control signal Sp does not change between time t23 to t24 when the load signal St is turned to 1 at the next timing after the writing of the above gradation signal Sd22, the level shifter 381 does not supply the operation signal to the analog switch 391. Therefore, as indicated by arrows Y9 and Y10, the charge sharing process is not performed on the gradation signal Sd22, during time t23 to t24, as illustrated in an area A6. As a result, during the display period of the time t24 and later when the load signal St is turned to 0, the gradation voltages corresponding to the gradation signal Sd22 are supplied as the output voltages Vd1 and Vd2 as they are.

When the gradation signal Sd21 indicating the gradation value 7fh is written between time td21 to td22, the charge sharing process is not performed, as illustrated in an area A5, between time t21 to t22 when the load signal St is turned to 1 next time, as indicated by arrows Y7 and Y8, similarly to the case indicated in FIG. 7. Consequently, during the display period from the time t22 to t23 when the load signal St is turned to 0 next time, the gradation voltages corresponding to the gradation signal Sd21 are supplied as the output voltages Vd1 and Vd2 as they are. Namely, the data driving circuit 213 does not perform the charge sharing process in the whole gradation range (00h to ffh) of the gradation signal Sd, when the polarity control signal Sp corresponding to the gradation signal Sd does not instruct the polarity inversion.

As mentioned above, the data driving circuit 213 according to the second embodiment performs the charge sharing process only when the gradation value of the gradation signal Sd is in the predetermined range and when the polarity control signal Sp corresponding to the gradation signal Sd instructs the polarity inversion, namely when a fluctuation in the gradation voltage actually gets large. Therefore, according to the second embodiment, it is possible to save the power consumption and to reduce the heat generation amount more properly than the case according to the first embodiment.

Also in the data driving circuit 213 according to the second embodiment, the boundary value is not restricted to 7fh but it may be set according to the gradation range of actually generating heat.

### Third Embodiment

Next, a third embodiment will be described. In the third embodiment, a data driving circuit will be described in the case of shorting not only between two adjacent data lines but also a predetermined number of the data lines.

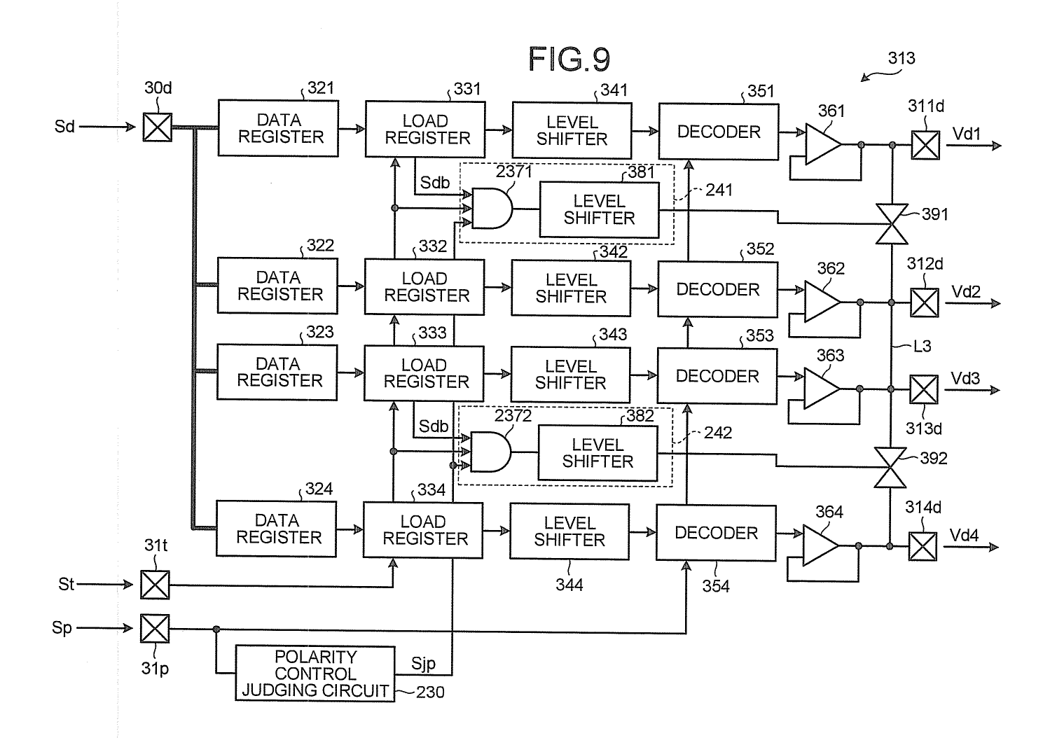

With reference to FIG. 9, the data driving circuit according to the third embodiment will be described.

FIG. 9 is a view for use in describing the structure of the data driving circuit according to the third embodiment. The liquid crystal display according to the third embodiment is formed by substituting a data driving circuit 313 described in FIG. 9 for the data driving circuit 13 of the liquid crystal display 1 shown in FIG. 1.

As illustrated in FIG. 9, the data driving circuit 313 according to the third embodiment has the structure of additionally connecting the data output terminals 312d and 313d via a wiring L3, compared with the data driving circuit 213 shown in FIG. 6.

The data driving circuit 313 can short between the adjacent data output terminals 311d and 312d, namely the data lines D1 and D2 by turning on the switch 391. The data driving circuit 313 can short between the adjacent data output terminals 313d and 314d, namely the data lines D3 and D4 by turning on the analog switch 392.

The data driving circuit 313 can short the four data output terminals 311d to 314d by turning on the analog switches 391 and 392 simultaneously. The data driving circuit 313 can short the four data lines D1 to D4 by turning on the analog switches 391 and 392 simultaneously.

Therefore, in the data driving circuit 313, the AND circuit 2371 and the AND circuit 2372 supply 1 to the level shifter 381 and the level shifter 382 respectively when all the values of the upmost bit Sdb of the entered gradation signal Sd, the load signal St, and the polarity judging signal Sjp are 1 in the both AND circuits. Consequently, the level shifters 381 and 382 supply the operation signals to the both analog switches 391 and 392. Then, both of the analog switches 391 and 392 are turned on. As a result, the four data lines D1 to D4 are shorted, and the charge is charged/discharged between the four data lines D1 to D4. In this case, the data lines D1 to D4 are shorted. Further, the charge/discharge is completed in a shorter time than in the case in shorting the two data lines D1 and D2.

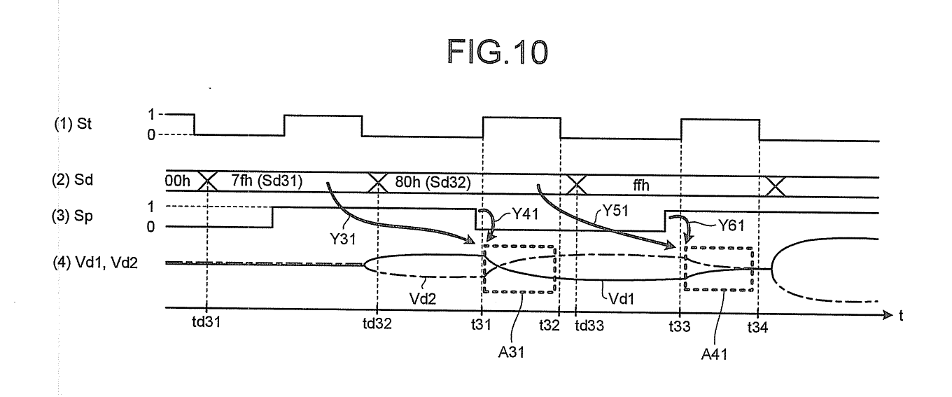

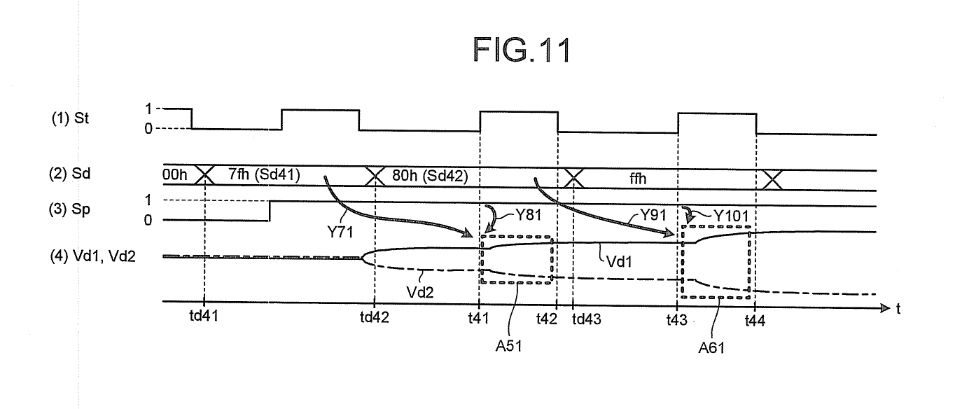

Specifically, the output voltages supplied from the data output terminals 311d and 312d in the data driving circuit 313 shown in FIG. 9 will be described with reference to FIGS. 10 and 11. FIG. 10(1) is a timing chart of the load signal St entered into the data driving circuit 313. FIG. 10(2) is a timing chart of the gradation signal Sd entered into the data driving circuit 313. FIG. 10(3) is a timing chart of the polarity control signal Sp entered into the data driving circuit 313. FIG. 10(4) is a timing chart of the output voltages Vd1 and Vd2 supplied from the data output terminals 311d and 312d of FIG. 9.

FIG. 11(1) is another timing chart of the load signal St entered into the data driving circuit 313. FIG. 11(2) is another timing chart of the gradation signal Sd entered into the data driving circuit 313. FIG. 11(3) is another timing chart of the polarity control signal Sp entered into the data driving circuit 313. FIG. 11(4) is another timing chart of the output voltages Vd1 and Vd2 supplied from the data output terminals 311d and 312d of FIG. 9.

As illustrated in FIG. 10(2), when a gradation signal Sd31 having the gradation value 7fh is written into both data registers 321 and 323, between time td31 to td32, the upmost bit of the gradation signal Sd31 is 0 similarly to the second embodiment. Therefore, the level shifters 381 and 382 don't supply the operation signal to any of the analog switches 391 and 392. Therefore, as indicated by arrows Y31 and Y41, the charge sharing process among the data lines D1 to D4 is not performed on the gradation signal Sd31, as illustrated in an area A31 of FIG. 10(4). As a result, at the time t31 when the load signal St is turned to 1, each polarity of the gradation voltages is inverted according to a change of the polarity control signal Sp in FIG. 10(3), and during the display period from the time t32 to t33 when the load signal St indicates 0 next time, the gradation voltages for the gradation signal Sd31 are supplied as the output voltages Vd1 and Vd2.

As illustrated in FIG. 10, a description will be made in the case where a gradation signal Sd32 having the gradation value 80h is written in the both data registers 321 and 323 between time td32 to td33 and where the polarity control signal Sp is turned from 1 to 0 so as to instruct the polarity inversion, between time t33 to t34 when the load signal St is turned to 1 at the next timing after the writing of the gradation signal Sd32. In this case, the level shifters 381 and 382 supply the operation signals to the both analog switches 391 and 392. Therefore, as indicated by arrows Y51 and Y61, with respect to the gradation signal Sd32, the analog switches 391 and 392 are both turned on, during time t33 to t34, and the charge sharing process for charging/discharging the charge is performed among the four data lines D1 to D4 as illustrated in an area A41.

In this case, since the four data lines D1 to D4 are shorted, the charge/discharge can be completed in a shorter time than in the case of shorting between the two data lines D1 and D2 (refer to the area A4 in FIG. 7). Consequently, at the time t33 when the load signal St is turned to 1, each polarity of the gradation voltages is inverted, and during the display period of the time t34 and later, the gradation voltages corresponding to the gradation value 80h of the gradation signal Sd32 are supplied as the output voltages Vd1 and Vd2.

Similarly to the second embodiment, as illustrated in FIG. 11, even when a gradation signal Sd42 having the gradation value 80h is written between time td42 to td43, the level shifter 381 does not supply the operation signal to the analog switch 391 when the polarity control signal Sp does not change during time t43 to t44 when the load signal St is turned to 1 at the next timing after the writing of the gradation signal Sd42. Therefore, as indicated by arrows Y91 and Y101, the charge sharing process is not performed on the gradation signal Sd42, as illustrated in an area A61. Therefore, during the display period of the time t44 and later when the load signal St indicates 0 next time, the gradation voltages corresponding to the gradation signal Sd42 are supplied as the output voltages Vd1 and Vd2 as they are.

When the gradation signal Sd41 indicating the gradation value 7fh is written between time td41 to td42, no charge sharing process is performed, as indicated by arrows Y71 and Y81, during time t41 to t42 when the load signal St is turned to 1 next time, as illustrated in an area A51. Therefore, during the display period from time t42 to t43 when the load signal St indicates 0 next time, the gradation voltages corresponding to the gradation signal Sd41 are supplied as the output voltages Vd1 and Vd2 as they are.

When one of the analog switches 391 and 392 is turned on, three of the four data lines are shorted, and in this case, the charge can be charged/discharged in a shorter time than in the case of shorting the two data lines.

As mentioned above, the data driving circuit 313 according to the third embodiment can short a predetermined number of data lines not only the adjacent two data lines. Therefore, in the third embodiment, the charge can be charged/discharged in a shorter time than in the case of shorting between the two adjacent data lines. As a result, according to the third embodiment, it is possible to perform the output processing of the gradation voltage to the liquid crystal display panel 11 more efficiently.

The data driving circuit 313 shown in FIG. 9 has been described by way of example, in the case of shorting all the illustrated data output terminals; however, it is not restricted to this. For example, by changing the connection state of the data output terminals, the data output terminals can be shorted by the unit of a predetermined number.

While certain embodiments have been described, these embodiments have been presented by way of example only, and are not intended to limit the scope of the inventions. Indeed, the novel devices and methods described herein may be embodied in a variety of other forms; furthermore, various omissions, substitutions and changes in the form of the devices and methods described herein may be made without departing from the sprit of the inventions. The accompanying claims and their equivalents are intended to cover such forms or modifications as would fall within the scope and spirit of the inventions.

What is claimed is:

1. A liquid crystal display, comprising:
a plurality of liquid crystal cells which display individual colors independently; and
a data driving circuit which supplies gradation voltages corresponding to colors displayed by the plurality of liquid crystal cells to the respective liquid crystal cells, in which
the data driving circuit includes
a plurality of data lines connected to the plurality of respective liquid crystal cells,
a plurality of gradation voltage supplying units which are connected to the plurality of respective data lines to supply the gradation voltages corresponding to the colors displayed by the liquid crystal cells to the plurality of respective liquid crystal cells, and
a plurality of charge sharing units short at least the adjacent gradation voltage supplying unit, at a position posterior to the respective gradation voltage supplying units and prior to the data lines to which the respective gradation voltage supplying units are connected, when a gradation value of a gradation signal indicating the color is in a predetermined range.

2. The liquid crystal display according to claim 1, wherein
when an upmost bit of the gradation signal is a predetermined value, the plurality of charge sharing units shorts at least the adjacent gradation voltage supplying unit, at the position posterior to the respective gradation voltage supplying units and prior to the data lines to which the respective gradation voltage supplying units are connected.

3. The liquid crystal display according to claim 1, further comprising
an operation signal supplying unit that supplies an operation signal to the plurality of charge sharing units when the upmost bit of the gradation signal is a predetermined value.

4. The liquid crystal display according to claim 3, wherein
when the operation signal supplying unit supplies the operation signal, the plurality of charge sharing units shorts at least the adjacent gradation voltage supplying unit, at the position posterior to the respective gradation voltage supplying units and prior to the data lines to which the respective gradation voltage supplying units are connected.

5. The liquid crystal display according to claim 1, further comprising
an operation signal supplying unit that supplies the operation signal to the plurality of charge sharing units, when the upmost bit of the gradation signal is a first predetermined value and a load signal for instructing a supplying timing of the gradation voltage is a second predetermined value.

6. The liquid crystal display according to claim 1, wherein
when the gradation value of the gradation signal indicating the color is in a predetermined range and a polarity control signal for instructing a polarity inversion of the gradation voltage instructs the polarity inversion, the plurality of charge sharing units shorts at least the adjacent gradation voltage supplying unit, at the position posterior to the respective gradation voltage supplying units and prior to the data lines to which the respective gradation voltage supplying units are connected.

7. The liquid crystal display according to claim 1, further comprising
a polarity control judging unit that supplies a polarity judging signal indicating a polarity judgment, when the polarity control signal for instructing the polarity inversion of the gradation voltage instructs the polarity inversion, and
an operation signal supplying unit that supplies an operation signal to the plurality of charge sharing units, when the gradation value of the gradation signal indicating the color is in a predetermined range and the polarity control judging unit supplies the polarity judging signal.

8. The liquid crystal display according to claim 1, further comprising
an polarity control judging unit that supplies the polarity judging signal indicating a polarity judgment, when the polarity control signal for instructing the polarity inversion of the gradation voltage instructs the polarity inversion, and
an operation signal supplying unit that supplies the operation signal to the plurality of charge sharing units, when the upmost bit of the gradation signal is a first predetermined value and the load signal for instructing the supplying timing of the gradation voltage is a second predetermined value, and when the polarity control judging unit supplies the polarity judging signal.

9. The liquid crystal display according to claim 1, wherein
a gradation range for performing the charge sharing process is set in accordance with the gradation range of generating a heat at the polarity inversion of the gradation voltage.

10. The liquid crystal display according to claim 1, wherein
the plurality of charge sharing units shorts the adjacent three or more gradation voltage supplying units, at the position posterior to the respective gradation voltage supplying units and prior to the data lines to which the respective gradation voltage supplying units are connected.

11. A data driving device which supplies gradation voltages corresponding to colors displayed by a plurality of liquid crystal cells to the plurality of respective liquid crystal cells for displaying individual colors independently, comprising
a plurality of data lines connected to the plurality of respective liquid crystal cells,
a plurality of gradation voltage supplying units which are connected to the plurality of respective data lines to supply the gradation voltages corresponding to the colors displayed by the liquid crystal cells to the plurality of respective liquid crystal cells, and
a plurality of charge sharing units short at least the adjacent gradation voltage supplying unit, at a position posterior to the respective gradation voltage supplying units and prior to the data lines to which the respective gradation voltage supplying units are connected, when a gradation value of a gradation signal indicating the color is in a predetermined range.

12. The data driving device according to claim 11, wherein
when an upmost bit of the gradation signal is a predetermined value, the plurality of charge sharing units shorts at least the adjacent gradation voltage supplying unit, at the position posterior to the respective gradation voltage supplying units and prior to the data lines to which the respective gradation voltage supplying units are connected.

13. The data driving device according to claim 11, further comprising
an operation signal supplying unit that supplies an operation signal to the plurality of charge sharing units when the upmost bit of the gradation signal is a predetermined value.

14. The data driving device according to claim 13, in wherein
when the operation signal supplying unit supplies the operation signal, the plurality of charge sharing units shorts at least the adjacent gradation voltage supplying unit, at the position posterior to the respective gradation voltage supplying units and prior to the data lines to which the respective gradation voltage supplying units are connected.

15. The data driving device according to claim 11, further comprising
an operation signal supplying unit that supplies the operation signal to the plurality of charge sharing units, when the upmost bit of the gradation signal is a first predetermined value and a load signal for instructing a supplying timing of the gradation voltage is a second predetermined value.

16. The data driving device according to claim 11, wherein
when the gradation value of the gradation signal indicating the color is in a predetermined range and a polarity control signal for instructing a polarity inversion of the gradation voltage instructs the polarity inversion, the plurality of charge sharing units shorts at least the adjacent gradation voltage supplying unit, at the position posterior to the respective gradation voltage supplying units and prior to the data lines to which the respective gradation voltage supplying units are connected.

17. The data driving device according to claim 11, further comprising
a polarity control judging unit that supplies a polarity judging signal indicating a polarity judgment, when the polarity control signal for instructing the polarity inversion of the gradation voltage instructs the polarity inversion, and
an operation signal supplying unit that supplies an operation signal to the plurality of charge sharing units, when the gradation value of the gradation signal indicating the color is in a predetermined range and the polarity control judging unit supplies the polarity judging signal.

18. The data driving device according to claim 11, further comprising
an polarity control judging unit that supplies the polarity judging signal indicating a polarity judgment, when the polarity control signal for instructing the polarity inversion of the gradation voltage instructs the polarity inversion, and
an operation signal supplying unit that supplies the operation signal to the plurality of charge sharing units, when the upmost bit of the gradation signal is a first predetermined value and the load signal for instructing the supplying timing of the gradation voltage is a second predetermined value, and when the polarity control judging unit supplies the polarity judging signal.

19. The data driving device according to claim 11, wherein
a gradation range for performing the charge sharing process is set in accordance with the gradation range of generating a heat at the polarity inversion of the gradation voltage.

20. The data driving device according to claim 11, wherein
the plurality of charge sharing units shorts the adjacent three or more gradation voltage supplying units, at the position posterior to the respective gradation voltage supplying units and prior to the data lines to which the respective gradation voltage supplying units are connected.
